(19) United States
(12) Patent Application Publication
(10) Pub. No.: US 2025/0131628 A1
(43) Pub. Date: Apr. 24, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: Takayuki Suzuki, Kanagawa (JP)

(21) Appl. No.: 18/911,484

(22) Filed: Oct. 10, 2024

(30) Foreign Application Priority Data
Oct. 18, 2023 (JP) 2023-179319

(51) Int. Cl. G06T 11/60

(52) U.S. Cl. CPC G06T 11/60

(57) ABSTRACT

An information processing apparatus includes: one or more processors and/or circuitry which function as: a reception unit configured to receive selection of a template which is a target of editing processing; an obtainment unit configured to obtain operation history information indicating history of an editing operation in the editing processing; and a display control unit configured to display an operation guide associated with the selected template, which is received, on a display unit based on the operation history information.

### BACKGROUND OF THE INVENTION

### Field of the Invention

The present disclosure relates to a technique of performing an editing operation by using a template.

### Description of the Related Art

There is an editing application to create a card and the like by arranging an image or a text on a page. Since the editing application has various functions, there has been known a technique of displaying an operation guide corresponding to an operation by a user. Japanese Patent Laid-Open No. 2013-171517 discloses a technique in a case where a user redoes an operation in which help for guessed another operation desired by the user is displayed promptly.

### SUMMARY OF THE INVENTION

An information processing apparatus according to the present disclosure includes: one or more processors and/or circuitry which function as: a reception unit configured to receive selection of a template which is a target of editing processing; an obtainment unit configured to obtain operation history information indicating history of an editing operation in the editing processing; and a display control unit configured to display an operation guide associated with the selected template, which is received, on a display unit based on the operation history information.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a system;

FIG. 2 is a block diagram illustrating a hardware configuration of an information processing apparatus;

FIG. 3 is a block diagram illustrating a hardware configuration of a printing apparatus;

FIG. 4 is a block diagram illustrating a hardware configuration of a server;

FIG. 5 is a block diagram illustrating a software configuration of the information processing apparatus;

FIG. 6 is a diagram illustrating a home screen of the information processing apparatus;

FIG. 7 is a diagram illustrating a top screen of a printing application;

FIG. 8 is a diagram illustrating a template selection screen;

FIG. 9 is a diagram illustrating a sheet size selection screen;

FIG. 10 is a diagram illustrating an image selection screen;

FIG. 11 is a diagram illustrating an editing screen (a no-text inputted state);

FIG. 12 is a diagram illustrating the editing screen (a text inputted state);

FIG. 13 is a diagram illustrating a printing setting screen;

FIG. 14 is a diagram illustrating the editing screen (an operation guide displayed state);

FIG. 15 is a flowchart illustrating processing of displaying the editing screen;

FIG. 16 is a flowchart illustrating processing of displaying the editing screen; and

FIG. 17 is a flowchart illustrating processing of displaying the editing screen.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

Additionally, in the embodiments described below, descriptions are given using a smartphone as an example of an information processing apparatus; however, a type of the information processing apparatus is not limited thereto. For example, various devices such as a mobile terminal other than a smartphone, a personal computer (PC) in the form of a laptop, a PC in the form of a desktop, a tablet terminal, a personal digital assistant (PDA), and a digital camera are applicable. Moreover, as long as it is a printer, it is possible to use an ink jet printer, a laser beam printer, and the like as a printing apparatus. Additionally, the printing apparatus may have not only a printing function but may be a multifunction peripheral with a scanning function to read a document, a copying function, and a facsimile function.

### First Embodiment

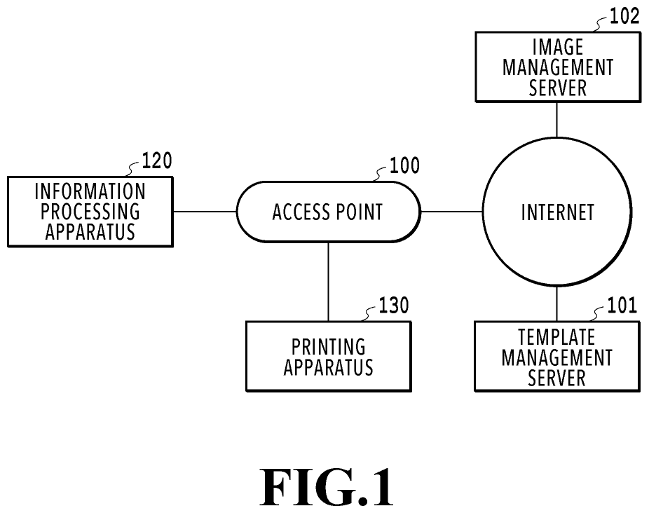

FIG. 1 is a diagram illustrating a configuration of a system in the present embodiment. The present system includes an information processing apparatus 120 and a printing apparatus 130. The information processing apparatus 120 communicates with the printing apparatus 130 via a network constructed by an access point 100 and allows the printing apparatus 130 to execute printing. The information processing apparatus 120 stores a program such as a printing application program (hereinafter, referred to as a “printing application”) described later. Therefore, printing data created by using this printing application is transmitted from the information processing apparatus 120 to the printing apparatus 130 via the network. Note that, the printing application is downloaded and installed into the information processing apparatus 120 via the network, for example. Additionally, the printing application may be installed from a recording medium attached to the information processing apparatus 120, for example. Moreover, since the access point 100 in the present embodiment functions as a wireless LAN router, the information processing apparatus 120 is connected to the Internet via this wireless LAN router. Furthermore, a case where the information processing apparatus 120 is connected to the Internet by another method such as a wired LAN is also included in the present disclosure. Therefore, the information processing apparatus 120 can communicate with a template management server 101 and an image management server 102 through the Internet. Note that, although FIG. 1 illustrates only one printing apparatus 130, plural printing apparatuses 130 may be connected to the access point 100.

The template management server 101 is a server that manages a template (format information) used by the printing application. The image management server 102 is a server that can save image data captured by a user with a camera. Note that, each server described above is a server system and may be formed of a single server PC or may be formed of plural server PCs. In other words, processing executed by each server described above may not be executed by only the single server PC but may be executed by the cooperation of the plural server PCs. Note that, the template is region information in which contents (objects) such as an image and a text are arranged.

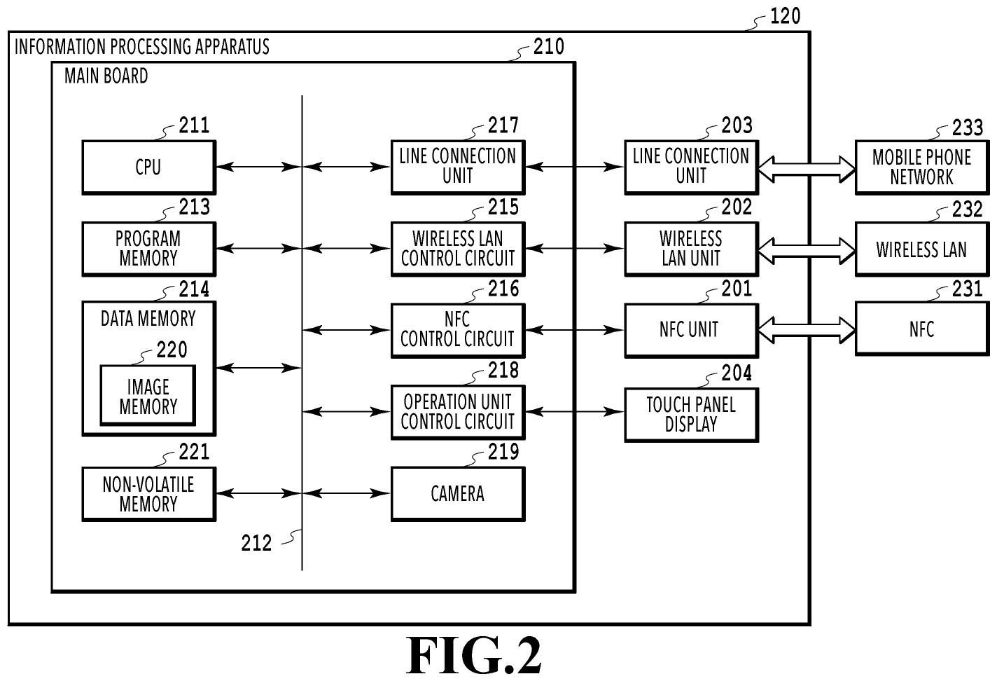

FIG. 2 is a block diagram illustrating a hardware configuration of the information processing apparatus 120 in the present embodiment. The information processing apparatus 120 includes a main board 210 controlling overall the apparatus, a wireless LAN unit 202, an NFC unit 201, a line connection unit 203, and a touch panel display 204 operating a function of the printer and displaying information of the printer. In this case, the NFC unit 201, the wireless LAN unit 202, and the line connection unit 203 can establish communications by using NFC communication, a wireless LAN, and a mobile phone network, respectively.

A CPU 211 in the form of a microprocessor arranged on the main board 210 operates in accordance with a control program stored in a program memory 213 in the form of a ROM connected via an internal bus 212 and contents of a data memory 214 in the form of a RAM. The program memory 213 can store a program such as an embedded operating system (OS) and a printing application in the present embodiment. In the present embodiment, software execution control of each application program stored in the program memory 213 is performed under management by the OS. Specifically, the CPU 211 reads the application program stored in the program memory 213 into the data memory 214 in the form of a RAM and execute the application program.

The CPU 211 communicates with another device using a wireless LAN by controlling the wireless LAN unit 202 via a wireless LAN control circuit 215. Note that, the wireless LAN unit 202 can establish data (packet) communication by a communication method complying with the IEEE 802.11 series (IEEE 802.11a, 11b, 11g, 11n, 11ac, 11ax, and so on), for example.

Additionally, the CPU 211 can detect connection of the NFC with another NFC terminal and transmit and receive data to and from the other NFC terminal by controlling the NFC unit 201 via an NFC control circuit 216. In addition, the CPU 211 can be connected to a mobile phone network and make a phone call or transmit and receive data by controlling the line connection unit 203 via a line control circuit 217. Moreover, a unit to perform a communication method of Bluetooth (registered trademark) Low Energy (BLE) may be included.

The CPU 211 can perform displaying on the touch panel display 204 and receive an operation from the user by controlling an operation unit control circuit 218. The CPU 211 can capture an image by controlling a camera unit 219, and the captured image is stored into an image memory 220 in the data memory 214. Additionally, in addition to the captured image, the CPU 211 can store an image obtained from the outside through the mobile phone network, the wireless LAN, or the NFC into the image memory 220 as well and can also transmit the image to the outside. A non-volatile memory 221 is formed of a memory such as a flash memory and stores data that is desired to be saved even after the power is turned off. For example, phone book data, various types of communication connection information, information of a device connected in the past, image data, and the like are stored. Application program management information managed by the printing application in the present embodiment is also stored in the non-volatile memory 221.

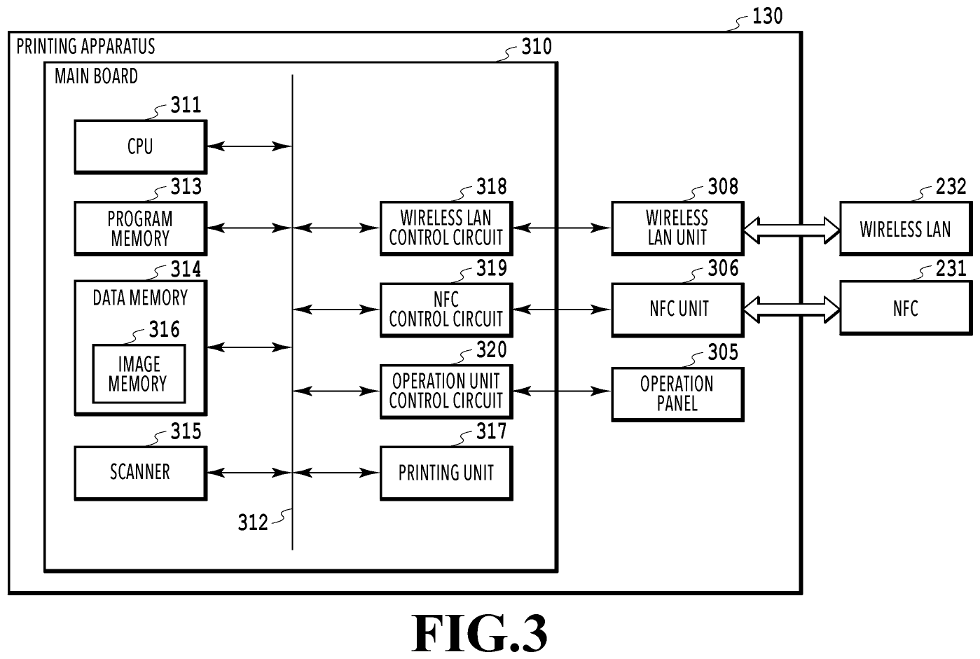

FIG. 3 is a block diagram illustrating a hardware configuration of the printing apparatus 130 in the present embodiment. The printing apparatus 130 includes a main board 310 controlling overall the apparatus, a wireless LAN unit 308, an NFC unit 306, and an operation panel 305. In this case, the wireless LAN unit 308 and the NFC unit 306 function as a communication unit of the printing apparatus 130.

A CPU 311 in the form of a microprocessor arranged on the main board 310 operates in accordance with a control program stored in a program memory 313 in the form of a ROM connected via an internal bus 312 and contents of a data memory 314 in the form of a RAM. The CPU 311 reads a document by controlling a scanner unit 315 and stores the document into an image memory 316 in the data memory 314.

Additionally, the CPU 311 can print an image in the image memory 316 in the data memory 314 on a printing medium by controlling a printing unit 317. Moreover, the CPU 311 also can transmit the scanned image data to an information processing apparatus 120 by way of the wireless LAN unit 308 controlled by a wireless LAN control circuit 318. Note that, although the printing unit 317 performs printing by an ink jet method in the present embodiment, it is not limited to this mode. Printing may be performed by another method such as an electrophotographic method or a thermal sublimation method.

The CPU 311 communicates with another device using a wireless LAN by controlling the wireless LAN unit 308 through the wireless LAN control circuit 318. Note that, the wireless LAN unit 308 can establish data (packet) communication by the communication method complying with the IEEE 802.11 series (IEEE 802.11a, 11b, 11g, 11n, 11ac, 11ax, and so on), for example. Additionally, the CPU 311 can detect connection of the NFC with another NFC terminal and transmit and receive data to and from the other NFC terminal by controlling the NFC unit 306 via an NFC control circuit 319. Note that, a communication method of the communication that can be executed by the printing apparatus 130 is not limited to the above. For example, communication established by Bluetooth Classic, Bluetooth Low Energy, or another communication method may be possible.

The CPU 311 can display a state of the printing apparatus 130 and display a function selection menu on the operation panel 305 by controlling an operation display unit control circuit 320 and can receive the operation from the user. The printing apparatus 130 in the present embodiment can perform printing by receiving a printing job including data in a JPEG file format to which a printer control instruction is applied.

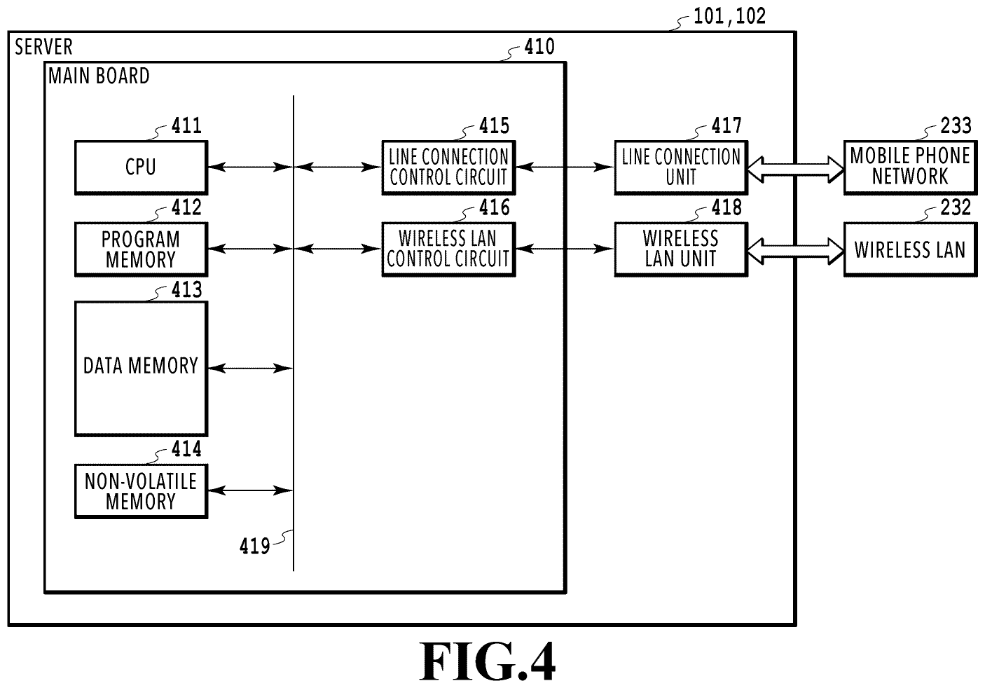

FIG. 4 is a block diagram illustrating a hardware configuration of the template management server 101 and the image management server 102 in the present embodiment. Each server includes a main board 410 controlling overall the apparatus, a wireless LAN unit 418, and a line connection unit 417. In this case, the wireless LAN unit 418 and the line connection unit 417 can establish communication by using the wireless LAN and the mobile phone network, respectively.

A CPU 411 in the form of a microprocessor arranged on the main board 410 operates in accordance with a control program stored in a program memory 412 in the form of a ROM connected via an internal bus 419 and contents of a data memory 413 in the form of a RAM. The program memory 412 can store a program such as the embedded operating system (OS). In the present embodiment, software execution control of each application program stored in the program memory 412 is performed under management by the OS. Specifically, the CPU 411 reads the application program stored in the program memory 412 into the data memory 413 in the form of a RAM and execute the application program.

The CPU 411 communicates with another device using a wireless LAN by controlling the wireless LAN unit 418 via a wireless LAN control circuit 416. Note that, the wireless LAN unit 418 can establish data (packet) communication by the communication method complying with the IEEE 802.11 series (IEEE 802.11a, 11b, 11g, 11n, 11ac, 11ax, and so on), for example. In addition, the CPU 411 can be connected to a mobile phone network and make a phone call or transmit and receive data by controlling the line connection unit 417 via a line control circuit 415.

A non-volatile memory 414 is formed of a memory such as a flash memory and stores data that is desired to be saved even after the power is turned off. For example, in a case of the template management server 101, the template is stored, and in a case of the image management server 102, the image data is stored. Note that, configurations of the servers, the template management server 101 and the image management server 102, may not be completely the same.

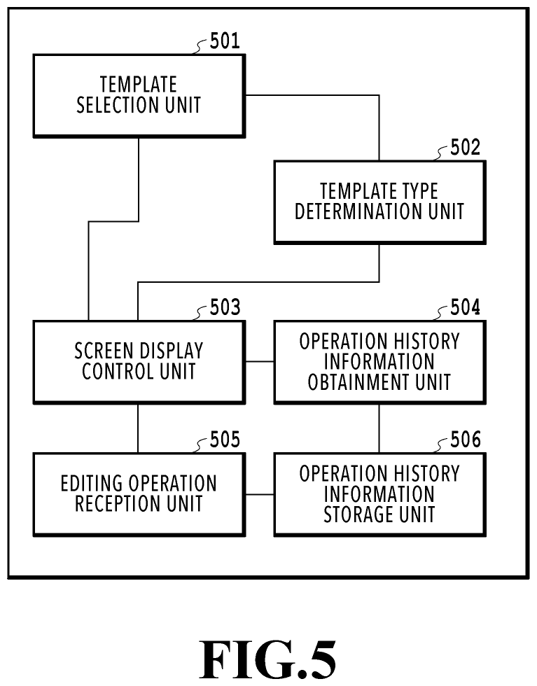

FIG. 5 is a diagram illustrating an example of a software configuration that is a function of the information processing apparatus 120. The software configuration of the information processing apparatus 120 includes a template selection unit 501, a template type determination unit 502, a screen display control unit 503, an operation history information obtainment unit 504, an editing operation reception unit 505, and an operation history information storage unit 506. These functional units are implemented in a case where the CPU 211 reads the application program stored in the program memory 213 into the data memory 214 in the form of a RAM and executes the application program.

The template selection unit 501 performs processing of receiving selection of the template used for editing and printing. The template type determination unit 502 determines a type of the template selected in the template selection unit 501. The operation history information obtainment unit 504 obtains operation history information stored in the operation history information storage unit 506. The screen display control unit 503 displays the template based on template information selected in the template selection unit 501 on the touch panel display 204. Additionally, the screen display control unit 503 displays an operation guide based on a result of the determination by the template type determination unit 502 and the operation history information obtained from the operation history information storage unit 506. Displaying of the operation guide is to display a region including information indicating an operation method to perform predetermined processing. The editing operation reception unit 505 receives an editing operation of the template displayed by the screen display control unit 503 on the touch panel display 204. The display on the touch panel display 204 is updated by the screen display control unit 503 by processing the editing result received by the editing operation reception unit 505. The operation history information storage unit 506 saves the operation history received by the editing operation reception unit 505 into the non-volatile memory 221.

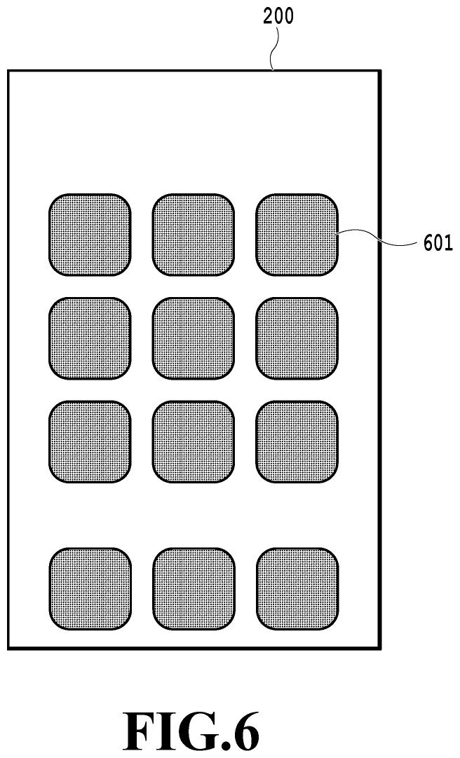

Next, a displayed screen of the printing application and an operation thereof in the present embodiment are described with reference to FIGS. 6 to 17. The displayed screens illustrated in FIGS. 6 to 14 are displayed on the touch panel display 204 with the CPU 211 executing the printing application stored in the program memory 213. Note that, each process to be executed in a state where a screen is displayed by the print application described below is realized by the CPU 211 reading a program of the printing application stored in the program memory 213 or the like into the memory 214 which is a RAM and executing the program of the printing application. Note that, not all the processings described below are necessarily executed sequentially on a single process. For example, there may be a case where, the subject of the processing is once moved to an OS side, the printing application is then called from the OS again, and the subsequent processing is executed by the printing application. Note that, in the present embodiment, it is assumed that setting to prevent displaying of the operation guide of the printing application is applied in the activation of the printing application for the second time or later.

FIG. 6 is a diagram illustrating a home screen in the information processing apparatus 120 in the present embodiment. The home screen is a screen on which an icon 601 corresponding to the application program installed on the information processing apparatus 120 is displayed by the OS and the like. The home screen may be, for example, a screen that is displayed first after the information processing apparatus 120 is activated. Additionally, the home screen may be a screen that is displayed first after a lock screen (not illustrated) of the information processing apparatus 120 is unlocked. With each icon being selected, the application program corresponding to the selected icon is activated.

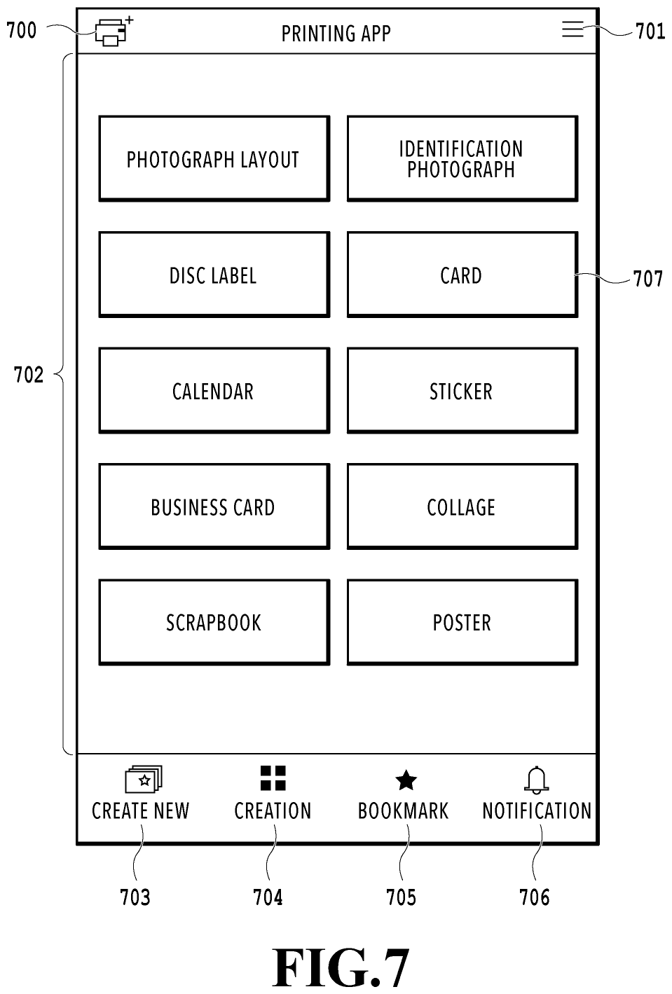

FIG. 7 is a diagram illustrating a top screen of the printing application. The screen illustrated in FIG. 7 displays a printer registration button 700, a menu button 701, a main display region 702, a create new button 703, a creation display button 704, a bookmark display button 705, and a notification display button 706. In a case where any one of the create new button 703, the creation display button 704, the bookmark display button 705, and the notification display button 706 is tapped, contents in accordance with the tapped button is displayed in the main display region 702. FIG. 7 illustrates a displayed example of the main display region 702 in a case where the printing application is activated, or the create new button 703 to create new printing data is tapped.

In a case where the printer registration button 700 is tapped, a not-illustrated printer registration screen is displayed. With registration processing via the printer registration screen, the printer as a target of the printing job transmission is selected, and setting is registered. In a case where the menu button 701 is tapped, version information, license information, and various types of information related to the printing application are displayed.

On the top screen illustrated in FIG. 7, plural category selection buttons 707 are displayed in the main display region 702. The category selection buttons 707 correspond to categories of creations that can be printed by the printing application in the present embodiment, respectively. Note that, in FIG. 7, texts such as “calendar” and “card” are displayed as the category selection buttons 707. Icons corresponding to the respective categories may be displayed with those texts. In a case where any one of the category selection buttons 707 is tapped, a displayed target on the touch panel display 204 transitions to a screen to print the template (contents) of the category corresponding to the tapped category selection button 707. Specifically, for example, in a case where the category selection button 707 indicating “collage” is tapped, the screen transitions to a screen to create a collage. Likewise, in a case where the category selection button 707 indicating “calendar” is tapped, the screen transitions to a screen to create a calendar. Note that, the template includes design data of a calendar, a card, or the like, information designating an arrangement place and a size of an image, printing sheet size information and a template name, and the like. Additionally, although the template is obtained from the template management server 101 in the present embodiment, there may be a template held by the printing application in advance. Moreover, depending on the category selection button 707 tapped by the user, whether it is a template that can be used for printing and whether there is an editing function such as image insertion to the template or text insertion to the template are different.

In a case where the creation display button 704 illustrated in FIG. 7 is tapped, a list of a thumbnail of the creation saved by the user is displayed in the main display region 702 in an icon state. The creation saved by the user is image data to be printed, which is created by the user by selecting one of the category selection buttons 707. Note that, in this list displaying, the creation may be distinguished for each category corresponding to the category selection button 707, and the thumbnail may be displayed accordingly. In a case where the bookmark display button 705 is tapped, a screen indicating a list of the template registered as a bookmark by the user is displayed in the main display region 702. In a case where the notification display button 706 is tapped, notification information such as an update notice of the template is displayed in the main display region 702.

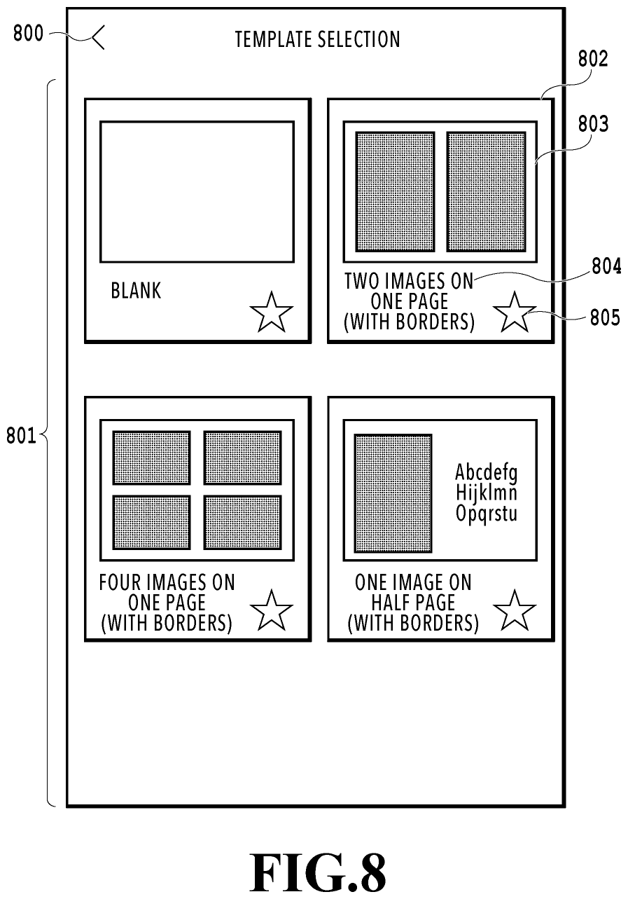

Next, a displayed example in a case where the category selection button 707 is tapped is described. In a case where any one of the category selection buttons 707 is tapped, the screen transitions to a template selection screen that displays a list of the template corresponding to the selected category. FIG. 8 is a diagram illustrating the template selection screen corresponding to a “photograph layout”. The template selection screen includes a return button 800 and a template information display region 801. In a case where the return button 800 is tapped, the displayed target on the touch panel display 204 transitions to the screen (the screen in FIG. 7) before the transition to the present screen.

The template information display region 801 displays plural pieces of template information 802. The template information 802 includes a template thumbnail 803 corresponding to each category, a template name 804, and a bookmark button 805. In a case where the bookmark button 805 is tapped, the corresponding template is registered with the bookmark. The template registered with the bookmark is displayed on the screen displayed by tapping the bookmark button 805. In a case where the desired template is tapped by the user in the template information 802, the screen transitions to a sheet size selection screen. A case where “one image on half page (with borders)” is selected from the template information 802 is described below as an example.

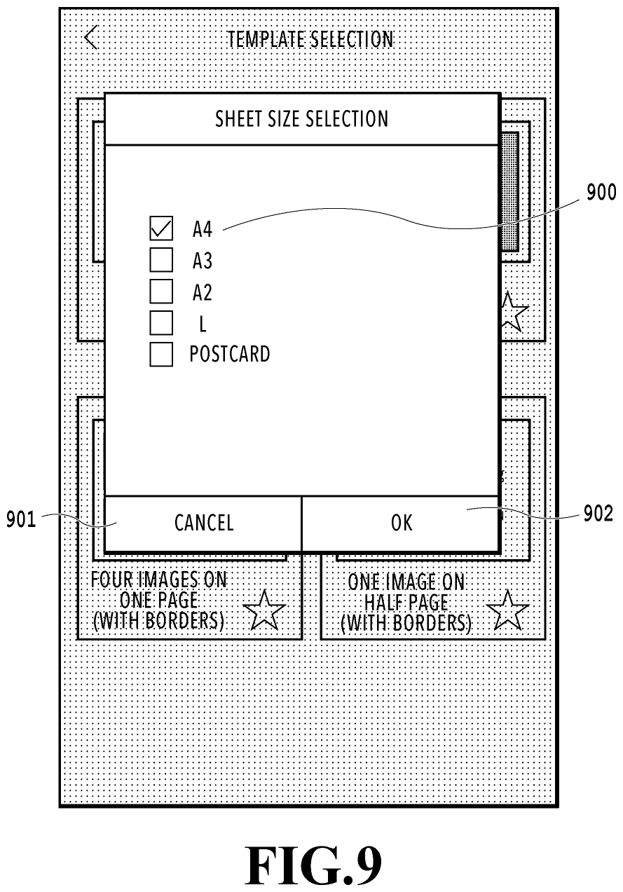

FIG. 9 is a diagram illustrating the sheet size selection screen. The sheet size selection screen includes a sheet size list 900, a cancel button 901, and an OK button 902. It is possible to designate a sheet size to be printed from the sheet size displayed in the sheet size list 900. In a case where the cancel button 901 is tapped, the displayed target on the touch panel display 204 transitions to the screen (the screen in FIG. 8) before the transition to the present screen. In a case where the OK button 902 is tapped, the screen transitions to an editing screen or an image selection screen depending on the selected template.

In the present embodiment, in a case where the template selected on the template selection screen is the template stored in the template management server 101, the printing application downloads the template in a case where the OK button 902 is tapped. The template downloaded in this case may include printing setting information appropriate for printing. Additionally, in a case where the downloaded template includes no image region, the printing application displays the editing screen corresponding to the template. In a case where the downloaded template includes the image region, the printing application displays the image selection screen. In a case where the image is selected on the image selection screen, the printing application displays the editing screen in which the selected image is embedded in the template. Note that, it is not limited to the above-described aspect. The printing application may download the template before the sheet size selection screen is displayed or while the sheet size selection screen is being displayed in a case where the template is selected on the template selection screen.

Additionally, in a case where the template selected on the template selection screen is the template held by the printing application in advance, the printing application performs the following operation without executing downloading from an external server. In a case where the template held in advance includes no image region, the printing application displays the editing screen corresponding to the template. In a case where the template held in advance includes the image region, the printing application displays the image selection screen. In a case where the image is selected on the image selection screen, the printing application displays the editing screen in which the selected image is embedded in the template.

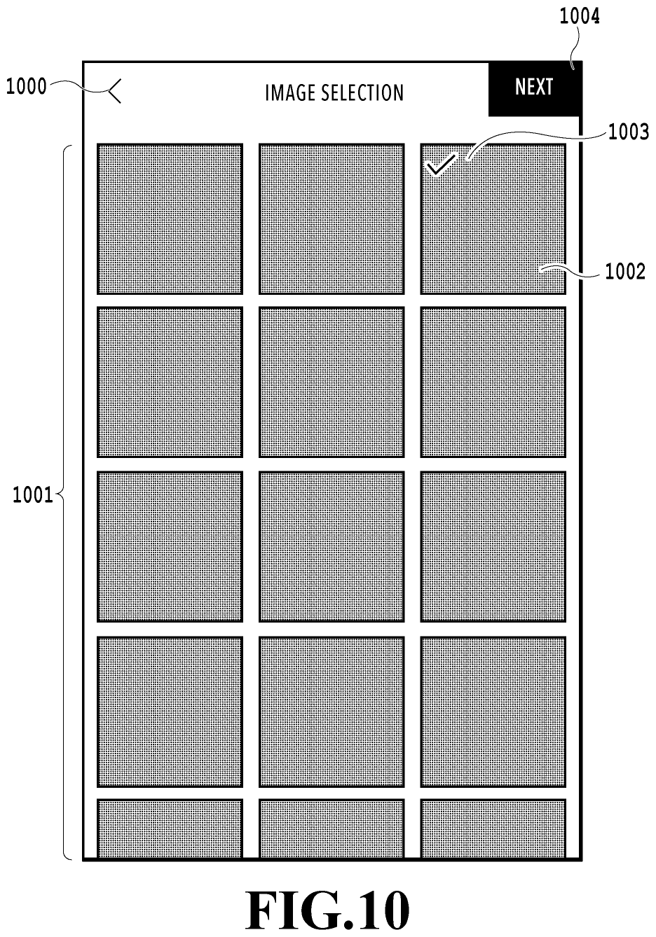

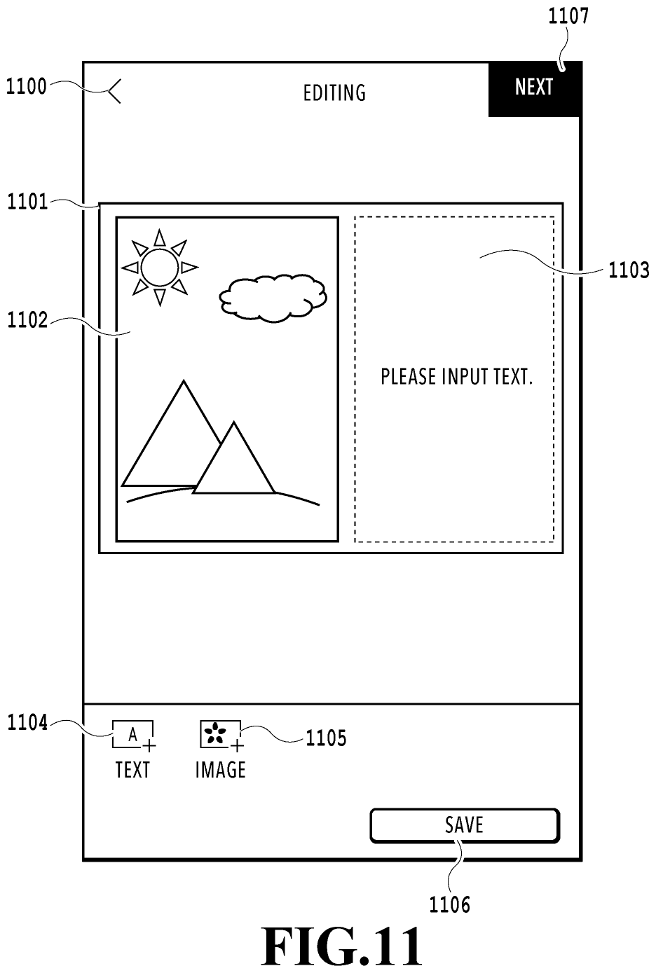

FIG. 10 is a diagram illustrating the image selection screen. The image selection screen includes a return button 1000, an image thumbnail display region 1001, and a next button 1004. In a case where the return button 1000 is tapped, the screen displayed on the touch panel display 204 transitions to the template selection screen illustrated in FIG. 8. The image thumbnail display region 1001 displays the image held by the information processing apparatus 120 and the image held by the image management server 102 as a thumbnail 1002. It is possible to combine one or more selected thumbnails 1002 with the template selected on the template selection screen illustrated in FIG. 8. The selected thumbnail 1002 displays a selection state icon 1003 to allow for determination on a selection state. In a case where the next button 1004 is tapped, the screen transitions to the editing screen illustrated in FIG. 11.

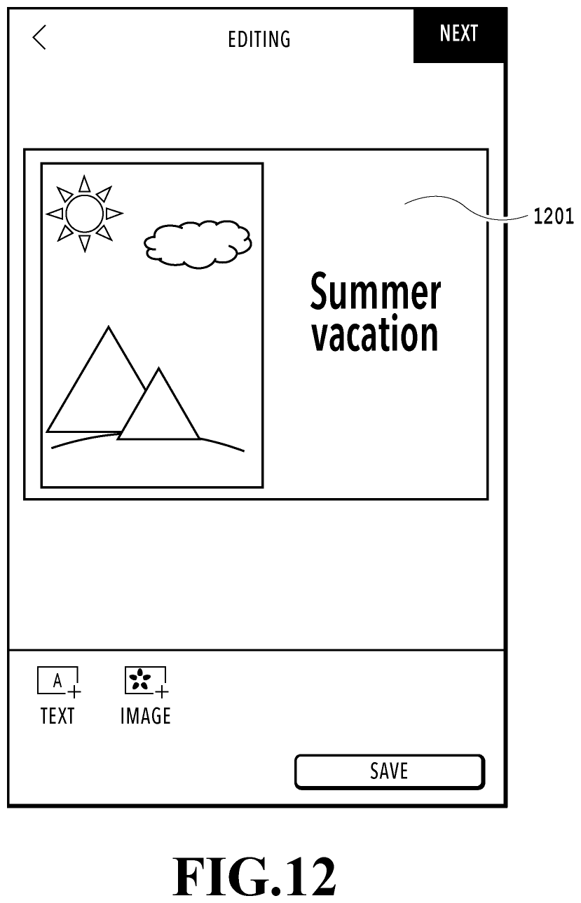

FIG. 11 is a diagram illustrating the editing screen. The editing screen includes a return button 1100, a page editing region 1101, an image region 1102, a text region 1103, a text button 1104, an image button 1105, a save button 1106, and a next button 1107. In a case where the return button 1100 is tapped, the screen displayed on the touch panel display 204 transitions to the template selection screen illustrated in FIG. 8. The page editing region 1101 indicates the creation generated based on the contents and the image selected by the user. The image region 1102 is displayed in a state in which the image selected in FIG. 10 is inserted. In a case where it is a no-text inputted state, the text region 1103 displays “Please input text” to prompt the user to insert the text. In a case where the text region 1103 is tapped, a not-illustrated screen to input the text is displayed. The text inputted on the screen is arranged in the text region 1103. FIG. 12 illustrates an example after the text is inputted to a text region 1201.

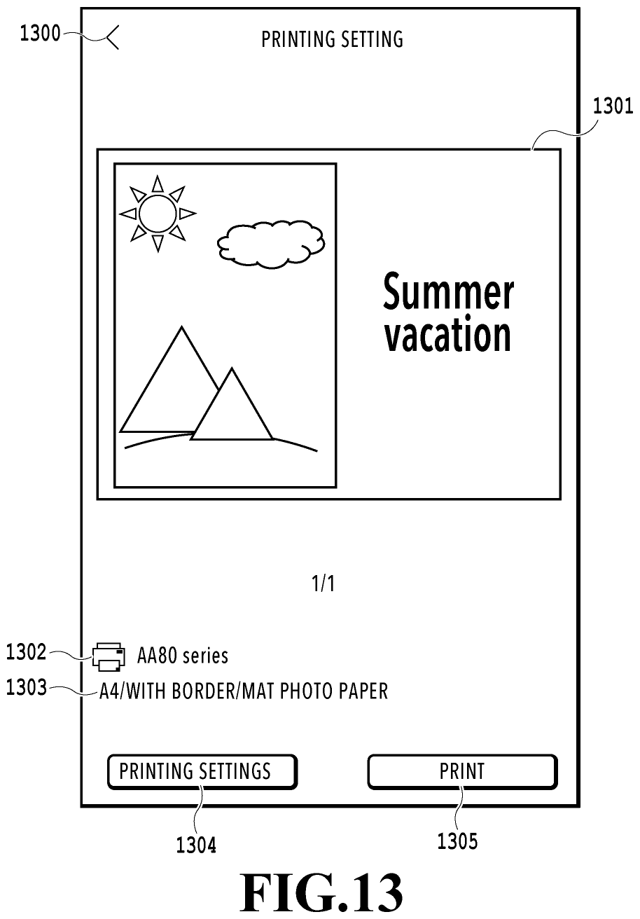

In a case where the text button 1104 is tapped, the history information based on operation information indicating that the text button 1104 is operated is stored in the non-volatile memory 221, and a screen to input the text (not illustrated) is displayed. The text inputted on the screen is arranged on the page as an additional text region on a layout defined in the template. Note that, the user may be allowed to set a position in which the text is arranged and a size and a color of the text. In a case where the image button 1105 is tapped, the history information based on operation information indicating that the image button 1105 is operated is stored in the non-volatile memory 221, and a screen to select the image (not illustrated) is displayed. In the screen, for example, the image held by the information processing apparatus 120 and the image held by the image management server 102 are the selection target. In a case where the image held by the image management server 102 is selected, the printing application obtains the selected image from the image management server 102. Note that, the image selected on the screen is arranged on the page as an additional image region on the layout defined in the template. Note that, the user may be allowed to set arbitrarily a position in which the image is arranged and a size of the image. Additionally, edited contents are reflected to the page editing region 1101 as needed. In a case where the save button 1106 is tapped, the contents corresponding to the page editing region 1101 currently displayed are saved. In a case where the next button 1107 is tapped, the screen transitions to a confirmation screen of the printing setting illustrated in FIG. 13. Although descriptions are given using the text button 1104 and the image button 1105 in the above-described example, it is not limited thereto. The present embodiment is also applicable to a case where various buttons are arranged on the screen as illustrated in FIG. 7. That is, the operation guide may be displayed for the button arranged on the screen on which no operation is performed.

FIG. 13 is a diagram illustrating the confirmation screen of the printing setting. The printing setting screen includes a return button 1300, a preview display region 1301, a registered printer information region 1302, a printing setting display region 1303, a printing setting button 1304, and a printing button 1305. In a case where the return button 1300 is tapped, the screen displayed on the touch panel display 204 transitions to the screen (the screen in FIG. 12) before the transition to the present screen. The preview display region 1301 displays a printing preview that includes displayed contents similar to that in the page editing region 1101 and that is based on the template selected by the user and an editing result of the template.

In a case where the printing setting button 1304 is tapped, a not-illustrated printing detail setting screen to change the printer as the target of the printing job transmission and the printing setting is displayed. On the printing detail setting screen, for example, it is possible to set and change the printer as the target of the printing job transmission, the number of printing copy, the type of the sheet used for printing, the size of the sheet used for printing, and the like. In the registered printer information region 1302, information of the printer currently set as the target of the printing job transmission is displayed. In the printing setting display region 1303, the printing setting currently set is displayed. In a case where the selected template includes the printing setting information, the printing setting is updated by using the printing setting information and is displayed in the printing setting display region 1303. Note that, in a case where the printer as the target of the printing job transmission or the printing setting is changed on the printing detail setting screen, and the printing setting screen illustrated in FIG. 13 is displayed again, the contents after the change are displayed in the registered printer information region 1302 and the printing setting display region 1303. Additionally, the contents displayed in the registered printer information region 1302 and the printing setting display region 1303 are stored in the program memory 213 or the non-volatile memory 221. Therefore, in a case where the printing application ends, and then the printing application is activated again, similar contents are displayed again in the registered printer information region 1302 and the printing setting display region 1303. Note that, in a case where the confirmation screen of the printing setting is displayed for the first time after the printing application is installed on the information processing apparatus 120, and the selected template includes no printing setting information, the following contents are displayed. That is, default setting defined in the printing application is displayed in the registered printer information region 1302 and the printing setting display region 1303.

In a case where the printing button 1305 is tapped, based on the set printing setting, transmission of the printing job for printing the template (the contents) selected and edited by the user in FIGS. 8 to 12 to the printing apparatus 130 is executed. Specifically, first, the CPU 211 executes rendering on the template (the contents) selected and edited by the user and converts the template into JPEG data. In addition, the CPU 211 applies a printing control instruction including the printing setting information and the like to the generated JPEG data and generates the printing job. The thus-generated printing job is transmitted to the printing apparatus 130. Note that, in a case where the printing job is transmitted, and while the printing based on the printing job is performed by the printing apparatus 130, the displayed target on the touch panel display 204 transitions to an in-printing screen (not illustrated). On the in-printing screen, a progress of the printing based on the printing job, contents of the printing setting of the transmitted printing job, a region to cancel the printing based on the printing job, and the like are displayed.

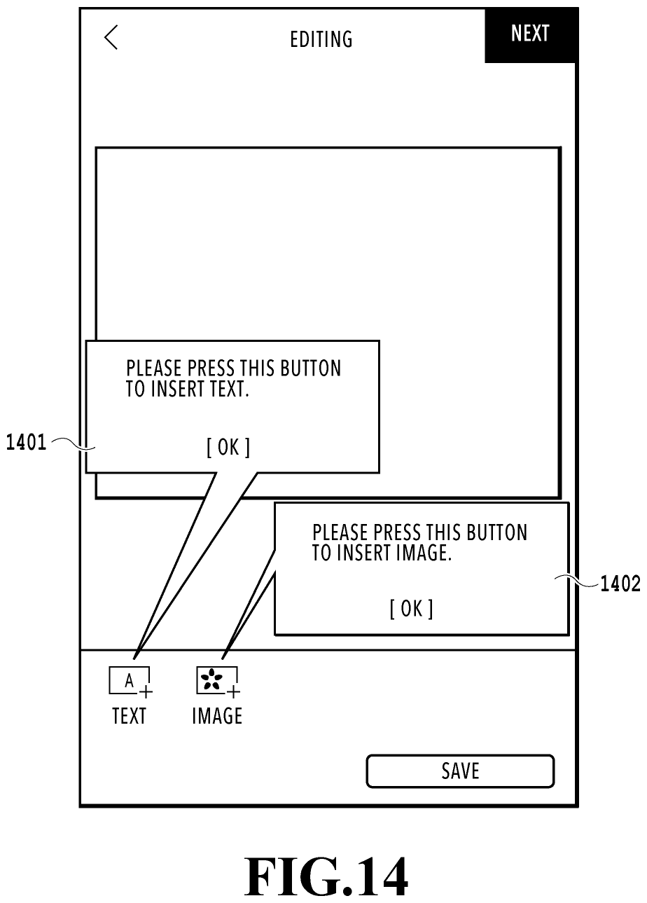

FIG. 14 is a diagram illustrating the editing screen in a state in which the operation guide is displayed in a case where a blank template is selected on the template selection screen illustrated in FIG. 8. In operation guides 1401 and 1402, descriptions of the text button 1104 and the image button 1105 which are editing operation targets necessary for the blank template are displayed. It is possible to close the operation guides 1401 and 1402 by tapping an OK button in each description text.

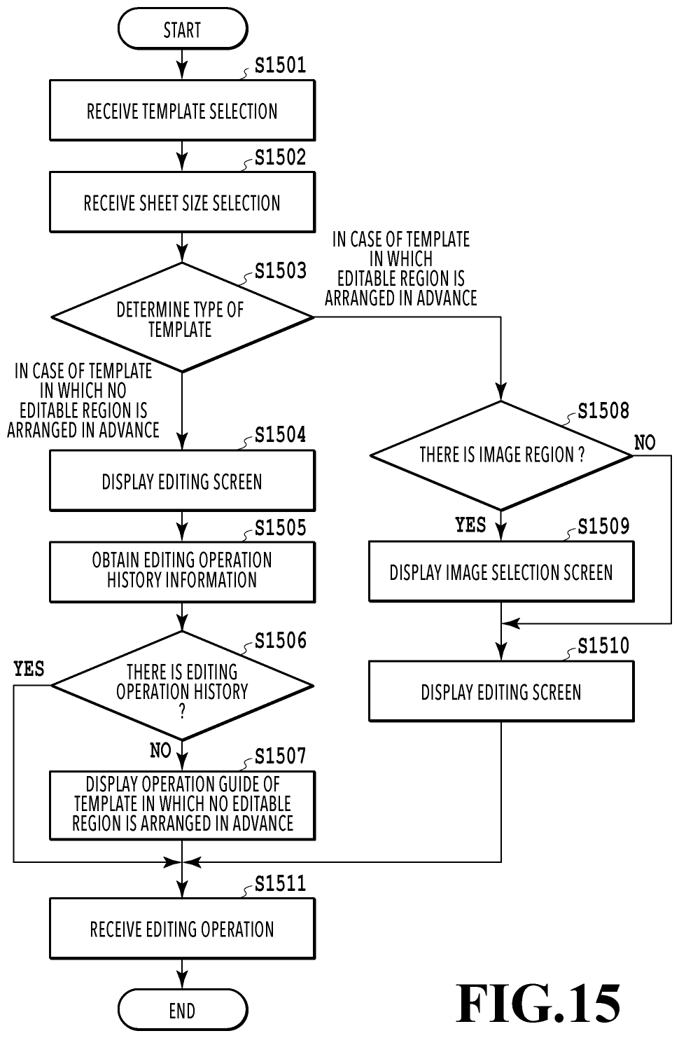

Next, a processing flow in the present embodiment is described. The processing in a flowchart illustrated in FIG. 15 is implemented with the CPU 211 reading out the program of the printing application stored in the program memory 213, the non-volatile memory 221, and the like to the data memory 214 as a RAM to execute. FIG. 15 is a diagram illustrating processing of displaying the editing screen in the present embodiment. The processing in the flowchart illustrated in FIG. 15 is started with the user pressing any one of the category selection buttons 707 on the top screen (FIG. 7) of the printing application to display the template selection screen (FIG. 8).

In S1501, the CPU 211 receives the selection of the template to be used to perform editing and printing on the template selection screen illustrated in FIG. 8 via the template selection unit 501. In a case where the selection of the template is received, the processing proceeds to S1502. In S1502, the CPU 211 obtains printable sheet size information included in the template designated in S1501, displays the sheet size selection screen illustrated in FIG. 9, and receives the selection of the sheet size. In a case where the selection of the sheet size is received, the processing proceeds to S1503. In S1503, the CPU 211 determines the type of the template selected in S1501 via the template type determination unit 502. The template can include all or any one of background region information, text region information, and image region information. The information of an editable region (editing region information) such as the text region information and the image region information is called an editing item. In this case, the editable region indicates a region corresponding to a type of an object to be edited. Regardless of the type of the selected template that is received, an operation button in accordance with the object is displayed on the touch panel display 204.

Additionally, there is also a specific template in which no editable region is arranged in advance. As an example, there may be the blank template that is a template in which the background region information is white, and no editable region is arranged in advance. A template of a solid image that is a template in which the background region information is a solid image of light gray and the like, and no editable region is arranged in advance may also be included. Additionally, a template that is a template in which no editable region is arranged in advance, and the background region information is a painting and the like may also be included. In a case where the CPU 211 determines that the type of the selected template is the template in which no editable region is arranged in advance, the processing proceeds to S1504. In a case where the CPU 211 determines that the type of the selected template is the template in which the editable region is arranged in advance, the processing proceeds to S1508.

In S1504, the CPU 211 displays the editing screen in accordance with the sheet size information designated in S1502 via the screen display control unit 503, and the processing proceeds to S1505. In S1505, the CPU 211 obtains the operation history information based on the operation information of the text button 1104 and the image button 1105 stored in the non-volatile memory 221 via the operation history information storage unit 506 and the operation history information obtainment unit 504. Specifically, the operation history information is information indicating whether the button such as the text button 1104 and the image button 1105 have been tapped before. Additionally, in a case where plural users log in the information processing apparatus 120, the operation history information is generated for each user. In a case where the operation history information is obtained, the processing proceeds to S1506. In S1506, the CPU 211 determines the operation history of the text button 1104 and the image button 1105 based on the obtained operation history information. In a case where there is the operation history of the text button 1104 or the image button 1105, the processing proceeds to S1511. In a case where there is no operation history of the text button 1104 and the image button 1105, the processing proceeds to S1507. In S1507, the CPU 211 displays the operation guide (an operation procedure) of the text button 1104 or the image button 1105 via the screen display control unit 503, and the processing proceeds to S1511. The operation guide (the operation procedure) for the blank template that is illustrated in FIG. 14 is an example thereof.

In S1508, the CPU 211 determines whether the selected template includes the image region information. In a case where the selected template includes the image region information, the processing proceeds to S1509. In a case where the selected template includes no image region information, the processing proceeds to S1510. In S1509, the CPU 211 displays the image selection screen illustrated in FIG. 10 via the screen display control unit 503, receives the selection of the image to be inserted, and the processing proceeds to S1510. In S1510, the CPU 211 displays the editing screen illustrated in FIG. 11 via the screen display control unit 503, and the processing proceeds to S1511. In S1511, the CPU 211 receives the editing operation on the displayed editing screen via the screen display control unit 503 and the editing operation reception unit 505. In a case where the editing operation is received, the processing in the flowchart illustrated in FIG. 15 ends.

In the present embodiment, in a case of the template in which no editable region is arranged in advance, it is possible to display the operation guide of the necessary editing operation based on the operation history information. That is, in a case where the user needs to perform an operation to add the image or to add the text depending on the type of the template, it is possible to allow the user to easily perform the editing operation by presenting an appropriate operation guide to the user. However, it is not limited thereto. As described above, the present embodiment is also applicable to a case where various buttons are arranged on the screen as illustrated in FIG. 7. That is, the operation guide may be displayed for the button arranged on the screen on which no operation is performed. Accordingly, it is possible to determine the operation guide to be displayed depending on the type of the template and to improve the operability of the application.

Although displaying of the operation guide of the printing application is described in the present embodiment, it is not limited thereto. The displaying method of the operation guide can also be executed on the application to perform the editing operation of another template. That is, the operability of the application to perform the editing operation of the template is improved by determining the operation guide to be displayed depending on the application and the selected template and displaying the operation guide as described in the present embodiment.

### Second Embodiment

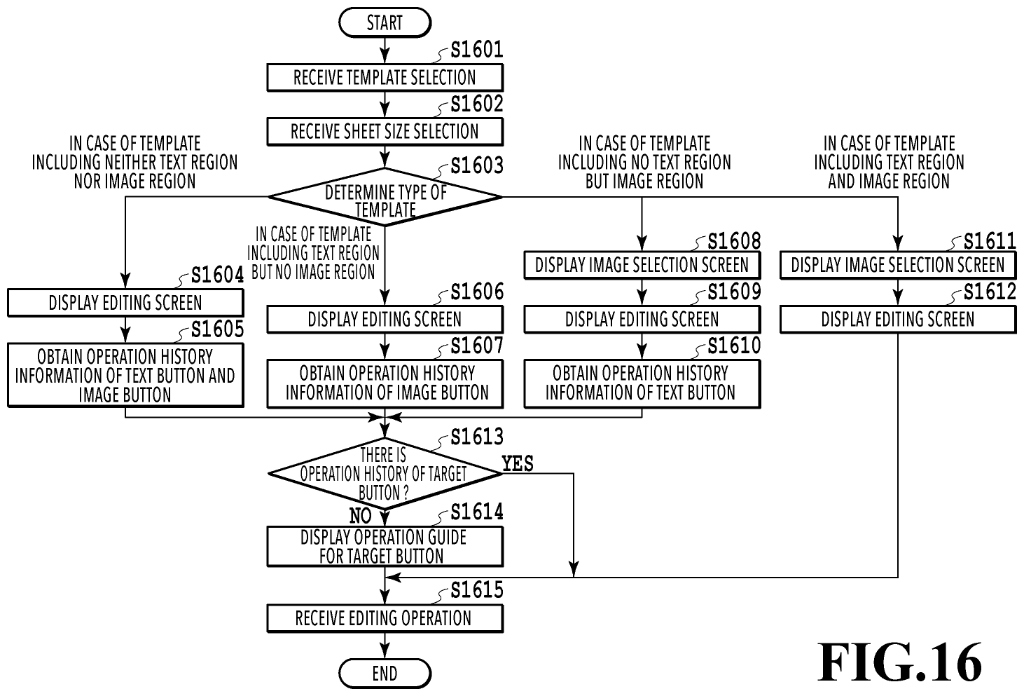

In the first embodiment, an aspect in which the operation guide is displayed in a case where the template in which no editable region is arranged in advance is selected is described. In the present embodiment, a mode in which the operation guide is displayed in a case where the template including the editable region is selected is described. FIG. 16 is a flowchart illustrating processing of displaying the editing screen in the present embodiment. The processing in the flowchart illustrated in FIG. 16 is started with the user pressing any one of the category selection buttons 707 on the top screen (FIG. 7) of the printing application to display the template selection screen (FIG. 8). The processing from S1601 to S1602 is the same as the processing from S1501 to S1502. Additionally, the text button 1104 and the image button 1105 are also referred to as the operation button.

In S1603, the CPU 211 determines the type of the template selected in S1601 via the template type determination unit 502. In a case where the CPU 211 determines that the selected template is the template in which no editable region is arranged in advance, that is, the template including neither the text region information nor the image region information, the processing proceeds to S1604. In a case where the CPU 211 determines that the selected template is a template including the text region information but no image region information, the processing proceeds to S1606. In a case where the CPU 211 determines that the selected template is a template including no text region but the image region information, the processing proceeds to S1608. In a case where the CPU 211 determines that the selected template is a template including both the text region information and image region information, the processing proceeds to S1611.

In S1604, the CPU 211 displays the editing screen in accordance with the sheet size information designated in S1602 via the screen display control unit 503, and the processing proceeds to S1605. In S1605, the CPU 211 obtains the operation history information based on the operation information of the text button 1104 and the image button 1105 (the operation button) stored in the non-volatile memory 221 via the operation history information storage unit 506 and the operation history information obtainment unit 504. In a case where the operation history information is obtained, the processing proceeds to S1613. In S1606, the CPU 211 displays the editing screen in accordance with the sheet size information designated in S1602 via the screen display control unit 503, and the processing proceeds to S1607. In S1607, the CPU 211 obtains the operation history information of the image button 1105 via the operation history information storage unit 506 and the operation history information obtainment unit 504, and the processing proceeds to S1613.

In S1608, the CPU 211 displays the image selection screen illustrated in FIG. 10 via the screen display control unit 503 and receives the selection of the image to be inserted via the editing operation reception unit 505, and the processing proceeds to S1609. In S1609, the CPU 211 displays the editing screen in accordance with the sheet size information designated in S1602 via the screen display control unit 503, and the processing proceeds to S1610. In S1610, the CPU 211 obtains the operation history information of the text button 1104 via the operation history information storage unit 506 and the operation history information obtainment unit 504, and the processing proceeds to S1613. In S1611, the CPU 211 displays the image selection screen illustrated in FIG. 10 via the screen display control unit 503 and receives the selection of the image to be inserted via the editing operation reception unit 505, and the processing proceeds to S1612. In S1612, the CPU 211 displays the editing screen in accordance with the sheet size information designated in S1602 via the screen display control unit 503, and the processing proceeds to S1615.

In S1613, the CPU 211 determines the obtained operation history of the target button. Specifically, whether there is the operation history of the image button 1105 is determined based on the operation history information of the image button 1105 obtained in S1607. In a case where the CPU 211 determines that there is no operation history of the target button, the processing proceeds to S1614. In a case where the CPU 211 determines that there is the operation history of the target button, the processing proceeds to S1615. In S1614, the CPU 211 displays the operation guide (the operation procedure) of the target button via the screen display control unit 503, and the processing proceeds to S1615. In S1615, the CPU 211 receives the editing operation on the displayed editing screen via the screen display control unit 503 and the editing operation reception unit 505. In a case where the editing operation is received, the processing flow of the flowchart illustrated in FIG. 16 ends.

Although the target button is the text button and the image button in the example in FIG. 16, it is not limited thereto. The selected template may include another region that is not illustrated, and the operation guide may be displayed for the operation button corresponding to the other region. As described above, in the present embodiment, it is possible to display the operation guide only in a case where the operation is performed on an editing element not included in the template by displaying the operation guide of the editing operation in accordance with the information included in the template. Accordingly, it is possible to display the guide that the user needs at an appropriate timing and with an appropriate amount of the information.

### Third Embodiment

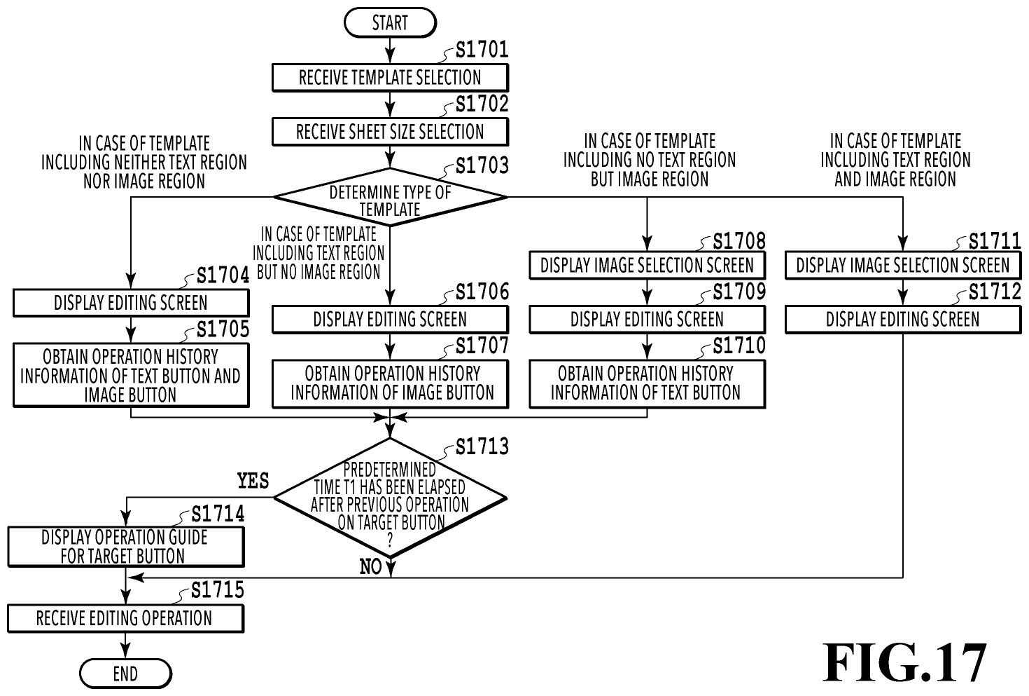

In the first embodiment, a mode in which the operation guide is displayed in the template in which no editable region is arranged in advance is described. In the second embodiment, a mode in which the operation guide is displayed in a case where the template including the editable region is selected, and there is no operation history of the button corresponding to the editable region is described. In the present embodiment, a mode in which the operation guide is displayed based on an elapsed time from the previous operation on the button corresponding to the editable region once the template including the editable region is selected is described. FIG. 17 is a flowchart illustrating processing of displaying the editing screen in the present embodiment. The processing in the flowchart illustrated in FIG. 17 is started with the user pressing any one of the category selection buttons 707 on the top screen (FIG. 7) of the printing application to display the template selection screen (FIG. 8). The processing from S1701 to S1712 and the processing from S1714 to S1715 are the same as the processing from S1601 to S1612 and the processing from S1614 to S1615. In S1713, the CPU 211 calculates the elapsed time from the previous operation on the target button and determines whether the elapsed time is a predetermined time (a specified value T1). In a case where the elapsed time is the predetermined time (the specified value T1) or more, the processing proceeds to S1714, and the CPU 211 displays the operation guide (the operation procedure) of the target button. In a case where the elapsed time is shorter than the predetermined time (the specified value T1), the processing proceeds to S1715.

In the present embodiment, considering the elapsed time from the previous operation for the conditions to display the operation guide in accordance with the information included in the template, it is possible to display the operation guide for also the user who forgets how to perform the editing operation using the target button. Accordingly, it is possible to allow the user to easily perform the editing operation by referring the displayed operation guide.

### Fourth Embodiment

In the first embodiment, a mode in which the operation guide is displayed in the template in which no editable region is arranged in advance is described. In the second embodiment, a mode in which the operation guide is displayed in a case where there is no operation history of the target button is described. In the third embodiment, a mode in which the operation guide is displayed based on the elapsed time from the previous operation on the button corresponding to the editable region once the template including the editable region is selected is described. In the present embodiment, a mode in which the operation guide is displayed in a case where the template in which no editable region is arranged in advance is selected, and a predetermined time has been elapsed after the editing screen (the template) is displayed.

In a case where the template in which no editable region is arranged in advance is selected, and the editing operation using the target button is not performed even in a case where a predetermined time (a specified value T2) has been elapsed after the editing screen (the template) is displayed, the operation guide of the target button is displayed. Additionally, a screen transition destination from the editing screen illustrated in FIG. 11 is the printing setting screen to which the transition is performed by tapping the next button 1107 in a case where an editing work is completed, and is the template selection screen to which the transition is performed by tapping the return button 1100 in a case of reselecting the template. In a case where the transition to a different screen is tried without performing any editing operation using the target button while the template in which no editable region is arranged in advance is selected, the operation guide (the operation procedure) of the target button is displayed before the transition to the different screen. That is, in a case where there is the operation on the target button before the transition to the different screen, the operation on the target button is received without the transition to the different screen. Thus, it is possible to allow the user who does not know how to operate the target button to execute the editing processing by operating the target button.

In the present embodiment, it is possible to display the operation guide in a case where the template in which no editable region is arranged in advance is selected, and the predetermined time has been elapsed after the editing screen (the template) is displayed. It is possible to display the operation guide also in a case where the template in which no editable region is arranged in advance is selected, and the screen transitions without performing any user operation after the editing screen is displayed. Accordingly, it is possible to allow the user to perform the editing operation more easily by referring the displayed operation guide.

### OTHER EMBODIMENTS

The above-described embodiment(s) of the present disclosure can be realized by performing the following process. A recording medium to which program code of software for realizing the functions of the above-described embodiments is recorded is supplied to a system or an apparatus. Then, a computer (or a central processing unit (CPU) or a micro processing unit (MPU)) of the system or the apparatus reads and executes the program code stored in the recording medium. Accordingly, the above-described functions can be realized. In this case, the program code read from the recording medium realizes the functions of the above-described embodiments, and the recording medium that stores the program code constitutes the present disclosure.

As the recording medium for supplying the program code, for example, a flexible disk, a hard disk, an optical disk, a magneto-optical disk, a compact disc read-only memory (CD-ROM), a compact disc recordable (CD-R), a magnetic tape, a nonvolatile memory card, a ROM, or a digital versatile disc (DVD) can be used.

The present disclosure includes not only a case where the functions of the above exemplary embodiments are achieved by executing a program code read by a computer, but also a case where based on an instruction from the program code, an operating system (OS) operating on the computer performs a part or all of actual processing, and the functions of the above-described exemplary embodiments are achieved by the processing.

Further, the program code read from the recording medium may be written to a memory included in a function extension board that is inserted into the computer or a memory included in a function extension unit that is connected to the computer. Then, a CPU and the like included in the function extension board or a CPU and like included in the function extension unit may perform part or all of the actual processing. With the processing, the functions of the above-described embodiments of the present disclosure are realized.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-179319, filed Oct. 18, 2023, which is hereby incorporated by reference wherein in its entirety.

What is claimed is:

1. An information processing apparatus, comprising:
one or more processors and/or circuitry which function as:
a reception unit configured to receive selection of a template which is a target of editing processing;
an obtainment unit configured to obtain operation history information indicating history of an editing operation in the editing processing; and
a display control unit configured to display an operation guide associated with the selected template, which is received, on a display unit based on the operation history information.

2. The information processing apparatus according to claim 1, wherein
in the editing processing, an editable region is a region in accordance with a type of an object to be edited, and
the display control unit arranges an operation button in accordance with the object on the display unit regardless of a type of the selected template that is received.

3. The information processing apparatus according to claim 2, wherein
in a case where the type of the selected template that is received is a specific template in which no editable region is arranged in advance, the obtainment unit obtains information indicating whether the operation button arranged on the display unit is operated as the operation history information.

4. The information processing apparatus according to claim 3, wherein
in a case where the operation history information indicates that no operation on a first operation button is performed, the display control unit displays an operation guide of the first operation button.

5. The information processing apparatus according to claim 3, wherein
in a case where the operation history information indicates that an operation on a second operation button is performed, the display control unit does not display an operation guide of the second operation button.

6. The information processing apparatus according to claim 2, wherein
in a case where the type of the selected template that is received is a specific template in which no editable region is arranged in advance,
the obtainment unit obtains, as the operation history information, information indicating whether a predetermined time has been elapsed after the selected template, which is received, is displayed on the display unit without an operation on the operation button being performed.

7. The information processing apparatus according to claim 6, wherein
in a case where the operation history information indicates that the predetermined time has been elapsed without an operation on a first operation button is performed, the display control unit displays an operation guide of the first operation button.

8. The information processing apparatus according to claim 6, wherein
in a case where the operation history information indicates that the predetermined time has not been elapsed without an operation on a second operation button is performed, the display control unit does not display an operation guide of the second operation button.

9. The information processing apparatus according to claim 2, wherein
in a case where the type of the selected template that is received is a specific template in which no editable region is arranged in advance, and transition to a different screen is performed without an operation on the operation button arranged on the display unit is performed, the display control unit displays an operation guide of the operation button before the transition to the different screen.

10. The information processing apparatus according to claim 2, wherein
the obtainment unit obtains information indicating whether an operation on the operation button of the object corresponding to the editable region that is not arranged in advance in the selected template that is received as the operation history information.

11. The information processing apparatus according to claim 10, wherein
in a case where the operation history information indicates that no operation on a first operation button is performed, the display control unit displays an operation guide of the first operation button.

12. The information processing apparatus according to claim 10, wherein
in a case where the operation history information indicates that an operation on a second operation button is performed, the display control unit does not display an operation guide of the second operation button.

13. The information processing apparatus according to claim 2, wherein
the obtainment unit obtains information indicating that a predetermined time has been elapsed after a previous operation on the operation button of the object corresponding to the editable region that is not arranged in advance in the selected template that is received as the operation history information.

14. The information processing apparatus according to claim 13, wherein
in a case where the operation history information indicates that the predetermined time has been elapsed after the previous operation on the first operation button, the display control unit displays an operation guide of the first operation button.

15. The information processing apparatus according to claim 13, wherein
in a case where the operation history information indicates that the predetermined time has not been elapsed after the previous operation on the second operation button, the display control unit does not display an operation guide of the second operation button.

16. A method of controlling an information processing apparatus, comprising:
receiving selection of a template which is a target of editing processing;
obtaining operation history information indicating history of an editing operation in the editing processing; and
displaying an operation guide associated with the selected template, which is received, on a display unit based on the operation history information.

17. A non-transitory computer readable storage medium storing a program which causes a computer to execute a method of controlling an information processing apparatus, the method comprising:
receiving selection of a template which is a target of editing processing;
obtaining operation history information indicating history of an editing operation in the editing processing; and
displaying an operation guide associated with the selected template, which is received, on a display unit based on the operation history information.
